(19) United States
(12) Patent Application Publication
(10) Pub. No.: US 2010/0319353 A1
(43) Pub. Date: Dec. 23, 2010

(54) Multiple Fuel Circuits for Syngas/NG DLN in a Premixed Nozzle

(76) Inventor: John Charles Intile, Simpsonville, SC (US)

Correspondence Address: NIXON & VANDERHYE P.C., 901 NORTH GLEBE ROAD, 11TH FLOOR, ARLINGTON, VA, 22203, US

(21) Appl. No.: 12/487,274

(22) Filed: Jun. 18, 2009

(51) Int. Cl. F02C 7/22

(52) U.S. Cl. 60/772; 60/737

(57) ABSTRACT

A fuel/air premixer for use in a burner in a combustion system of an industrial gas turbine includes an air inlet, a fixed nozzle geometry, and an annular mixing passage. The fuel/air premixer mixes fuel and air in the annular mixing passage for injection into a combustor reaction zone. A plurality of fuel sources are connected with the fixed nozzle geometry, and each of the fuel sources is cooperable with the fixed nozzle geometry to effect multiple fuel flow variations including variations in fuel type, fuel blend, volumetric flow, and pressure ratios.

### BACKGROUND OF THE INVENTION

The present invention relates to heavy duty industrial gas turbines and, in particular, to a burner for an industrial gas turbine including a fuel/air premixer enabling mixtures of multiple gas streams for desired performance such as fuel mixing for emissions, flame holding robustness, and control of combustion oscillations.

Gas turbine manufacturers are currently involved in research and engineering programs to produce new gas turbines that will operate at high efficiency without producing undesirable air polluting emissions. The primary air polluting emissions usually produced by gas turbines burning conventional hydrocarbon fuels are oxides of nitrogen, carbon monoxide, and unburned hydrocarbons. It is well known in the art that oxidation of molecular nitrogen in air breathing engines is highly dependent upon the maximum hot gas temperature in the combustion system reaction zone. The rate of chemical reactions forming oxides of nitrogen (NOx) is an exponential function of temperature. If the temperature of the combustion chamber hot gas is controlled to a sufficiently low level, thermal NOx will not be produced.

One preferred method of controlling the temperature of the reaction zone of a heat engine combustor below the level at which thermal NOx is formed is to premix fuel and air to a lean mixture prior to combustion. The thermal mass of the excess air present in the reaction zone of a lean premixed combustor absorbs heat and reduces the temperature rise of the products of combustion to a level where thermal NOx is not formed.

There are several problems associated with dry low emissions combustors operating with lean premixing of fuel and air. That is, flammable mixtures of fuel and air exist within the premixing section of the combustor, which is external to the reaction zone of the combustor. There is a tendency for combustion to occur within the premixing section due to flashback, which occurs when flame propagates from the combustor reaction zone into the premixing section, or auto-ignition, which occurs when the dwell time and temperature for the fuel/air mixture in the premixing section are sufficient for combustion to be initiated without an igniter. The consequences of combustion in the premixing section are degradation of emissions performance and/or overheating and damage to the premixing section, which is typically not designed to withstand the heat of combustion. Therefore, a problem to be solved is to prevent flashback or auto-ignition resulting in combustion within the premixer.

In addition, the mixture of fuel and air exiting the premixer and entering the reaction zone of the combustor must be very uniform to achieve the desired emissions performance. If regions in the flow field exist where fuel/air mixture strength is significantly richer than average, the products of combustion in these regions will reach a higher temperature than average, and thermal NOx will be formed. This can result in failure to meet NOx emissions objectives depending upon the combination of temperature and residence time. If regions in the flow field exist where the fuel/air mixture strength is significantly leaner than average, then quenching may occur with failure to oxidize hydrocarbons and/or carbon monoxide to equilibrium levels. This can result in failure to meet carbon monoxide (CO) and/or unburned hydrocarbon (UHC) emissions objectives. Thus, another problem to be solved is to produce a fuel/air mixture strength distribution, exiting the premixer, which is sufficiently uniform to meet emissions performance objectives.

Still further, in order to meet the emissions performance objectives imposed upon the gas turbine in many applications, it is necessary to reduce the fuel/air mixture strength to a level that is close to the lean flammability limit for most hydrocarbon fuels. This results in a reduction in flame propagation speed as well as emissions. As a consequence, lean premixing combustors tend to be less stable than more conventional diffusion flame combustors, and high level combustion driven dynamic pressure activity often results. This high level dynamic pressure activity can have adverse consequences such as combustor and turbine hardware damage due to wear or fatigue, flashback or blow out. Thus, yet another problem to be solved is to control the combustion driven dynamic pressure activity to an acceptably low level.

Lean, premixing fuel injectors for emissions abatement are in common use throughout the industry, having been reduced to practice in heavy duty industrial gas turbines for more than two decades. A representative example of such a device is described in U.S. Pat. No. 5,259,184 assigned to the General Electric Company. Such devices have achieved great progress in the area of gas turbine exhaust emissions abatement. Reduction of oxides of nitrogen, NOx, emissions by an order of magnitude or more relative to the diffusion flame burners of prior art have been achieved without the use of diluent injection such as steam or water.

These gains in emissions performance, however, have been made at the expense of incurring several problems. In particular, flashback and flame holding within the premixing section of the device result in degradation of emissions performance and/or hardware damage due to overheating. In addition, increased levels of combustion driven dynamic pressure activity results in a reduction in the useful life of combustion system parts and/or other parts of the gas turbine due to wear or high cycle fatigue failures. Still further, gas turbine operational complexity is increased and/or operating restrictions on the gas turbine are necessary in order to avoid conditions leading to high-level dynamic pressure activity, flashback, or blow out.

In addition to these problems, conventional lean premixed combustors have not achieved maximum emission reductions possible with perfectly uniform premixing of fuel and air.

An example of a method for reducing the amplitude of combustion driven dynamic pressure activity in lean premixed dry low emissions combustors can be found in U.S. Pat. No. 5,211,004 assigned to General Electric Company. An improvement that builds on the principles of this prior art is described in U.S. Pat. No. 6,438,961, also assigned to General Electric Company. The patent describes controlling both fuel/air radial profile and fuel injection pressure drop to minimize or eliminate the amplification resulting from the weak limit oscillation cycle. The patent also describes unique features of the premixer that cause it to achieve performance improvements relative to the prior art in all of the problem areas noted above. The system achieves gas turbine exhaust emissions performance that is superior to prior art technology lean premixed dry low emissions combustor performance at elevated firing temperatures of the most advanced heavy-duty industrial gas turbines. In particular, the emissions of oxides of nitrogen (NOx) are minimized without compromising carbon monoxide (CO) or unburned hydrocarbon (UHC) emissions performance. Additionally, the patent improves on the resistance to flashback and flame holding within the premixer relative to current technology lean premixed dry low emissions combustors for heavy-duty industrial gas turbine application. Still further, the patent reduces the level of combustion driven dynamic pressure activity and increases the margin to lean blow out over the entire operating range of the gas turbine relative to current technology lean premixed dry low emissions combustors for heavy duty industrial gas turbines.

It would be desirable to increase the number of fuel inlets/passages in the prior system to allow mixtures of multiple gas streams to enter the premixing passage for desired performance. Added fuel inlets also will allow large Wobbe index variations with a fixed nozzle geometry.

### BRIEF DESCRIPTION OF THE INVENTION

In an exemplary embodiment, a fuel/air premixer is for use in a burner in a combustion system of an industrial gas turbine. The fuel air premixer includes an air inlet, at least two fuel inlets, a corresponding at least two fuel sources coupled with the at least two fuel inlets, and an annular mixing passage. The fuel/air premixer mixes fuel and air in the annular mixing passage for injection into a combustor reaction zone. A swozzle assembly is disposed downstream of the air inlet. The swozzle assembly may include a plurality of turning vanes positioned to impart swirl to incoming air. Each of the turning vanes includes an internal fuel flow passage communicating with at least one of the fuel inlets. At least some of the fuel inlets and the fuel sources are controllable to effect fuel blending and to effect Wobbe index variations within a fixed geometry.

In another exemplary embodiment, a fuel/air premixer for use in a burner in a combustion system of an industrial gas turbine includes an air inlet, a fixed nozzle geometry, and an annular mixing passage, where the fuel/air premixer mixes fuel and air in the annular mixing passage for injection into a combustor reaction zone. A plurality of fuel sources are connected with the fixed nozzle geometry, and at least some of the fuel sources are cooperable with the fixed nozzle geometry to effect multiple fuel flow variations including variations in fuel type, fuel blend, volumetric flow, and pressure ratios.

In yet another exemplary embodiment, a method of premixing fuel and air in a burner in a combustion system of an industrial gas turbine includes the steps of (a) flowing multiple fuel streams into the annular mixing passage via the fuel inlets; (b) controlling fuel blending and fuel mixture for desired performance; and (c) controlling volumetric flow and pressure ratios of at least some of the fuel streams to accommodate Wobbe index variations within a fixed geometry.

### BRIEF DESCRIPTION OF THE DRAWINGS

FIG. 1 is a cross-section view through the conventional burner;

FIG. 2 illustrates the air swirler or swozzle assembly of the premixer according to the conventional burner;

FIG. 3 is a close-up view of the turning vanes of the swozzle assembly illustrated in FIG. 2; and

FIG. 4 is a schematic illustration of a preferred embodiment incorporating multiple fuel passages.

### DETAILED DESCRIPTION OF THE INVENTION

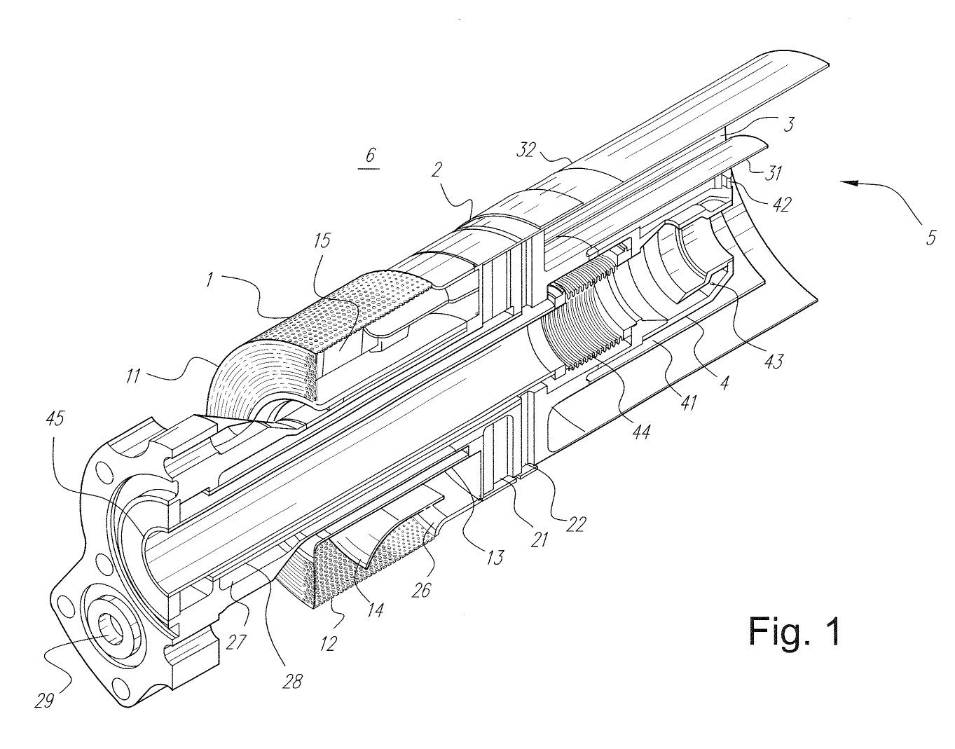

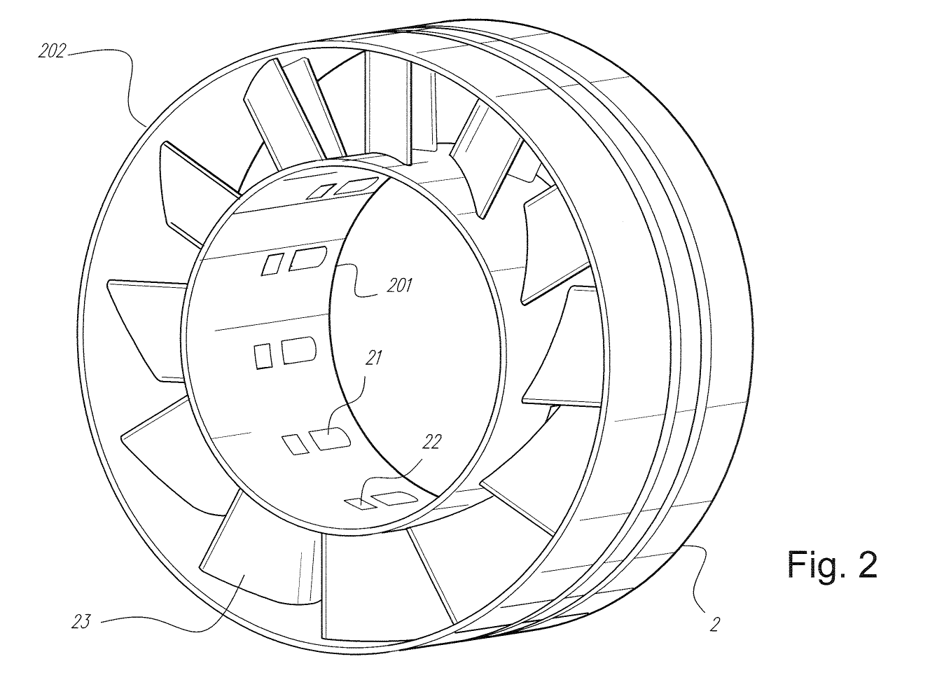

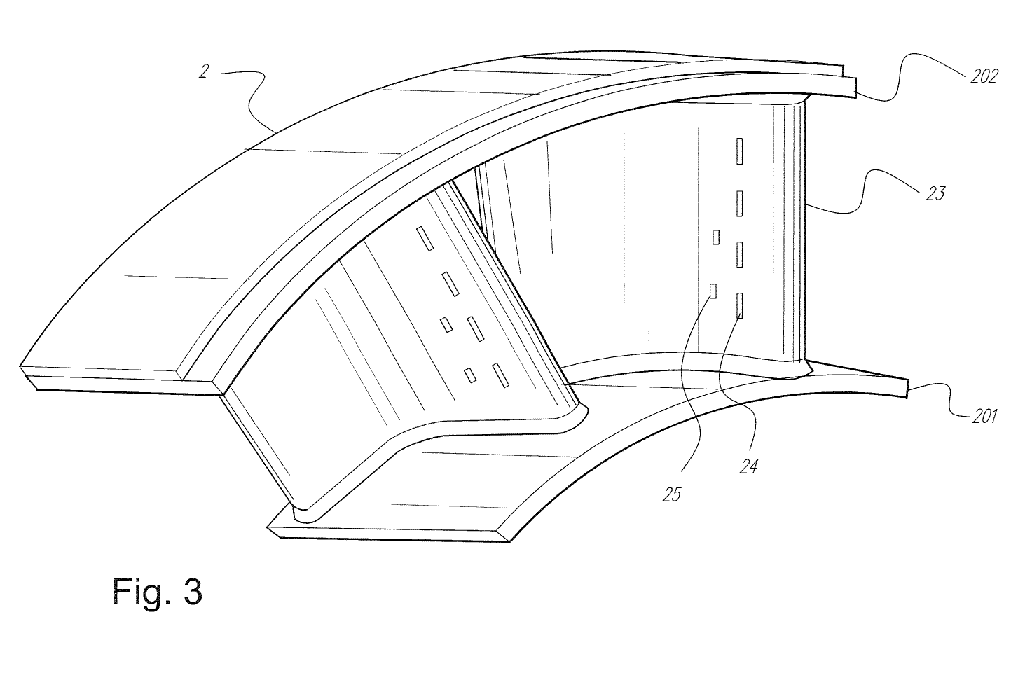

FIG. 1 is a cross-section through the burner described in U.S. Pat. No. 6,438,961, and FIGS. 2 and 3 show details of the air swirler assembly with fuel injection through the turning vanes or swozzle. In practice, an air atomized liquid fuel nozzle would be installed in the center of the burner assembly to provide dual fuel capability; however, this liquid fuel nozzle assembly does not form part of the invention and has been omitted from the illustrations for clarity. The burner assembly is divided into four regions by function including an inlet flow conditioner 1, an air swirler assembly with natural gas fuel injection (referred to as a swozzle assembly) 2, an annular fuel air mixing passage 3, and a central diffusion flame natural gas fuel nozzle assembly 4.

Air enters the burner from a high pressure plenum 6, which surrounds the entire assembly except the discharge end, which enters the combustor reaction zone 5. Most of the air for combustion enters the premixer via the inlet flow conditioner (IFC) 1. The IFC includes an annular flow passage 15 that is bounded by a solid cylindrical inner wall 13 at the inside diameter, a perforated cylindrical outer wall 12 at the outside diameter, and a perforated end cap 11 at the upstream end. In the center of the flow passage 15 is one or more annular turning vanes 14. Premixer air enters the IFC 1 via the perforations in the end cap and cylindrical outer wall.

The function of the IFC 1 is to prepare the air flow velocity distribution for entry into the premixer. The principle of the IFC 1 is based on the concept of backpressuring the premix air before it enters the premixer. This allows for better angular distribution of premix air flow. The perforated walls 11, 12 perform the function of backpressuring the system and evenly distributing the flow circumferentially around the IFC annulus 15, whereas the turning vane(s) 14, work in conjunction with the perforated walls to produce proper radial distribution of incoming air in the IFC annulus 15. Depending on the desired flow distribution within the premixer as well as flow splits among individual premixers for a multiple burner combustor, appropriate hole patterns for the perforated walls are selected in conjunction with axial position of the turning vane(s) 14. A computer fluid dynamic code is used to calculate flow distribution to determine an appropriate hole pattern for the perforated walls. A suitable computer program for this purpose is entitled STAR CD by Adapco of Long Island, N.Y.

To eliminate low velocity regions near the shroud wall 202 at the inlet to the swozzle 2, a bell-mouth shaped transition 26 is used between the IFC and the swozzle.

Experience with multi-burner dry low emissions combustion systems in heavy-duty industrial gas turbine applications has shown that non-uniform air flow distribution exists in the plenum 6 surrounding the burners. This can lead to non-uniform air flow distribution among burners or substantial air flow maldistribution within the premixer annulus. The result of this air flow maldistribution is fuel/mixture strength maldistribution entering the reaction zone of the combustor, which in turn results in degradation of emissions performance. To the extent that the IFC 1 improves the uniformity of air flow distribution among burners and within the premixer annulus of individual burners, it also improves the emissions performance of the entire combustion system and the gas turbine.

After combustion air exits the IFC 1, it enters the swozzle assembly 2. The swozzle assembly includes a hub 201 and a shroud 202 connected by a series of air foil shaped turning vanes 23, which impart swirl to the combustion air passing through the premixer. Each turning vane 23 contains a primary natural gas fuel supply passage 21 and a secondary natural gas fuel supply passage 22 through the core of the air foil. These fuel passages distribute natural gas fuel to primary gas fuel injection holes 24 and secondary gas fuel injection holes 25, which penetrate the wall of the air foil. These fuel injection holes may be located on the pressure side, the suction side, or both sides of the turning vanes 23. Natural gas fuel enters the swozzle assembly 2 through inlet ports 29 and annular passages 27, 28, which feed the primary and secondary turning vane passages, respectively. The natural gas fuel begins mixing with combustion air in the swozzle assembly, and fuel/air mixing is completed in the annular passage 3, which is formed by a swozzle hub extension 31 and a swozzle shroud extension 32. After exiting the annular passage 3, the fuel/air mixture enters the combustor reaction zone 5 where combustion takes place.

Since the swozzle assembly 2 injects natural gas fuel through the surface of aerodynamic turning vanes (airfoils) 23, the disturbance to the air flow field is minimized. The use of this geometry does not create any regions of flow stagnation or separation/recirculation in the premixer after fuel injection into the air stream. Secondary flows are also minimized with this geometry with the result that control of fuel/air mixing and mixture distribution profile is facilitated. The flow field remains aerodynamically clean from the region of fuel injection to the premixer discharge into the combustor reaction zone 5. In the reaction zone, the swirl induced by the swozzle 2 causes a central vortex to form with flow recirculation. This stabilizes the flame front in the reaction zone 5. However, as long as the velocity in the premixer remains above the turbulent flame propagation speed, flame will not propagate into the premixer (flashback); and, with no flow separation or recirculation in the premixer, flame will not anchor in the premixer in the event of a transient causing flow reversal. The capability of the swozzle 2 to resist flashback and flame holding is extremely important for application since occurrence of these phenomena would cause the premixer to overheat with subsequent damage.

FIGS. 2 and 3 show details of the swozzle geometry. As noted, there are two groups of natural gas fuel injection holes on the surface of each turning vane 23, including the primary fuel injection holes 24 and the secondary fuel injection holes 25. Fuel is fed to these fuel injection holes 24, 25 through the primary gas passage 21 and the secondary gas passage 22. Fuel flow through these two injection paths is controlled independently, enabling control over the radial fuel/air concentration distribution profile from the swozzle hub 201 to the swozzle shroud 202.

Radial fuel concentration profile is known to play a significant role in determining the performance of lean premixed dry low emissions combustors, having a significant influence on the combustion driven dynamic pressure activity, the emissions performance and turndown capability. The radial profile control provides a means of compensating for natural gas fuel volume flow rate variation due to changes in fuel heating value (composition) and/or supply temperature. An additional advantage of this novel fueling scheme is the potential to load reject to the secondary fuel passages since the resulting hub-rich configuration could sustain combustion at a fraction of full load fuel flow.

At the center of the burner assembly is a conventional diffusion flame fuel nozzle 4 having a slotted gas tip 42, which receives combustion air from an annular passage 41 and natural gas fuel through gas holes 43. The body of this fuel nozzle includes a bellows 44 to compensate for differential thermal expansions between this nozzle and the premixer. This fuel nozzle is used during ignition, acceleration, and a low load where the premixer mixture is too lean to burn. This diffusion flame fuel nozzle can also provide a pilot flame for the premixer to extend this range of operability. In the center of this diffusion flame fuel nozzle is a cavity 45, which is designed to receive a liquid fuel nozzle assembly to provide dual fuel capability.

The illustrated structure provides direct active control of the fuel/air radial profile to allow optimal performance over a range of operating conditions. It also allows the possibility of a new load rejection strategy that can help reduce the number of fuel systems and thus the overall system cost.

In addition to providing control of the fuel/air radial profile, supplying fuel to the premixer by two independently controllable flow paths provides a means of controlling the pressure drop across the fuel injection holes. This provides another method of controlling dynamic pressure activity because the response of the fuel injection to pressure waves in the premixer can be adjusted to match the air supply response. This capability is retained even when variations in fuel supply heating value and/or temperature make it necessary to vary the volume flow of fuel through the injector because the total effective area of the fuel injection holes can be adjusted by varying the fuel flow split between the two flow paths. This capability is not available with injectors having a single fixed area fuel flow path, which is typical of prior art. By matching the premixer fuel and air response to pressure waves, the dynamic pressure amplification resulting from the weak limit oscillation cycle can be minimized or eliminated.

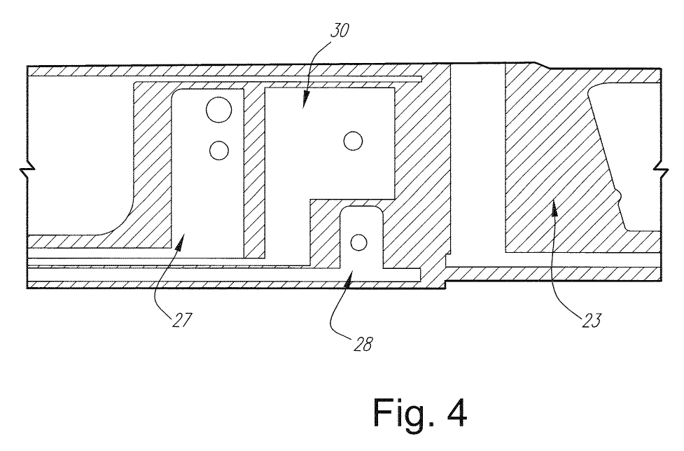

In a preferred embodiment, the design illustrated in FIGS. 1-3 can be expanded to allow multiple fuel streams of different compositions to enter the fuel/air premixer. For example, with reference to FIG. 4, a third fuel passage or fuel inlet 30 is added to allow mixtures of multiple gas streams such as synthetic gas (syngas) and natural gas to enter the premixing passage for desired performance such as fuel mixing for emissions, flame holding robustness, or control of combustion oscillations. Although one additional fuel passage or fuel inlet 30 is shown, many more fuel passages/inlets may be added. Each fuel passage 30 may utilize a blended syngas and methane flow or may rather flow just syngas while other circuits flow natural gas during operation. With this construction, large Wobbe index variations can be allowed by controlling both the volumetric flow and pressure ratios through the plurality of orifices that inject fuel into the premixed passage. That is, during operation, a passage may flow fuel through it and be turned “on” or “off” or somewhere between depending on the Wobbe index of the flowing fuel.

In the past, large volumetric flows associated with syngas fuels such as those with CO create potential flashback/flameholding challenges due to jet penetration or impact to aerodynamic performances of swirler vanes. Using multiple fuel passages as shown in FIG. 4 for applications such as syngas or variations in Wobbe index allow the use of a single nozzle geometry. The multiple fuel passages allow for control of jet momentum and other flameholding defects with a premixer system. Large blockages resulting from the fuel jets are avoided and thus disturbances to the vane aerodynamic performance are minimized. Additionally, using multiple fuel passages allows for the potential to blend multiple fuel streams such as syngas, methane or other fuels within the combustion system.

With the modified structure, the multiple fuel inlets in corresponding fuel sources are controllable to effect large Wobbe index variations (i.e., greater than 10%) within a fixed geometry. Operation of a turbine can thus be tuned to desired outputs for parameters or to address operational concerns by controlling fuel input and without requiring structural changes to the system.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A fuel/air premixer for use in a burner in a combustion system of a gas turbine, the fuel air premixer comprising:
an air inlet;
at least two fuel inlets;
a corresponding at least two fuel sources coupled with the at least two fuel inlets;
an annular mixing passage, wherein the fuel/air premixer mixes fuel and air in the annular mixing passage for injection into a combustor reaction zone; and
a swozzle assembly downstream of the air inlet, the swozzle assembly including a plurality of turning vanes positioned to impart swirl to incoming air, wherein each of the turning vanes includes an internal fuel flow passage communicating with at least one of the fuel inlets,
wherein at least some of the fuel inlets and the fuel sources are controllable to effect fuel blending and to effect Wobbe index variations within a fixed geometry.

2. A fuel/air premixer according to claim 1, wherein the at least two fuel sources comprise sources of different fuel types.

3. A fuel/air premixer according to claim 2, wherein the fuel types comprise natural gas, synthetic gas, methane, and blended synthetic gas and methane.

4. A fuel/air premixer according to claim 1, wherein at least some of the fuel inlets and the fuel sources are cooperable to effect control of volumetric flow and pressure ratios of the fuel.

5. A fuel/air premixer according to claim 1, wherein at least some of the fuel inlets and the fuel sources are controllable to effect fuel blending and to effect Wobbe index variations within the fixed geometry exceeding 10%.

6. A fuel/air premixer for use in a burner in a combustion system of an industrial gas turbine, the fuel air premixer comprising an air inlet, a fixed nozzle geometry, and an annular mixing passage, wherein the fuel/air premixer mixes fuel and air in the annular mixing passage for injection into a combustor reaction zone, wherein a plurality of fuel sources are connected with the fixed nozzle geometry, and wherein at least some of the fuel sources are cooperable with the fixed nozzle geometry to effect multiple fuel flow variations including variations in fuel type, fuel blend, volumetric flow, and pressure ratios.

7. A method of premixing fuel and air in a burner in a combustion system of an industrial gas turbine using a fuel/air premixer, the fuel/air premixer including an air inlet, at least two fuel inlets, a corresponding at least two fuel sources coupled with the at least two fuel inlets, an annular mixing passage, and a swozzle assembly downstream of the air inlet for imparting swirl to incoming air, the method comprising:
(a) flowing multiple fuel streams into the annular mixing passage via the fuel inlets;
(b) controlling fuel blending and fuel mixture for desired performance; and
(c) controlling volumetric flow and pressure ratios of at least some of the fuel streams to accommodate Wobbe index variations within a fixed geometry.

8. A method according to claim 7, wherein step (a) is practiced by flowing fuel streams including natural gas, synthetic gas, methane, and blended synthetic gas and methane.

9. A method according to claim 7, wherein step (c) is practiced by turning on and turning off at least some of the fuel streams depending on a Wobbe index of the respective fuel in the fuel streams.
